(19) United States
(12) Patent Application Publication
(10) Pub. No.: US 2024/0001602 A1
(43) Pub. Date: Jan. 4, 2024

(54) Extruded Reinforced Industrial Belt

(71) Applicant: Albany International Corp., Rochester, NH (US)

(72) Inventors: Mark J. Levine, Appleton, WI (US); Robert Hansen, North Muskegon, MI (US); Vivek Goel, Summerville, SC (US); Erin Lynn Camponeschi Brotherson, Avondale, PA (US)

(21) Appl. No.: 18/217,355

(22) Filed: Jun. 30, 2023

Related U.S. Application Data
(60) Provisional application No. 63/358,016, filed on Jul. 1, 2022.

(51) Int. Cl. B29C 48/00; D06N 3/00; B29C 48/08; B29C 48/285

(52) U.S. Cl. CPC B29C 48/022; D06N 3/0011; B29C 48/08; D06N 3/0086; D06N 3/007; B29C 48/2886; D06N 2211/04; B29K 2105/106

(57) ABSTRACT

The present disclosure relates to a nonwoven extruded industrial fabric. A method of manufacture of the industrial fabric is crosshead extruding a polymeric matrix material with linear components. The linear components crosshead extruded with the polymeric matrix material may be continuous systems oriented in the machine direction. The polymeric resin matrix at least partially encompasses one or more of the linear components. The resin matrix may likewise be further reinforced by the inclusion of nanoparticles, nanomaterials, and/or chopped fibers. A faceside of the industrial belt may be smooth or may include a texture or pattern.

### CROSS-REFERENCE TO RELATED APPLICATION

This application claims the benefit of priority under 35 U.S.C. § 119 of U.S. Provisional Patent Application Ser. No. 63/358,016, filed Jul. 1, 2022. The foregoing application is incorporated herein by reference in its entirety.

### FIELD OF THE DISCLOSURE

The present disclosure relates to a nonwoven extruded industrial fabric. The industrial fabric, such as a belt, is produced by co-extruding a polymeric matrix material with linear components oriented in the machine direction. A faceside of the industrial fabric may be smooth or may include a texture or pattern.

### BACKGROUND

During the papermaking process, a cellulosic fibrous web is formed by depositing a fibrous slurry, that is, an aqueous dispersion of cellulose fibers, onto a moving forming fabric in the forming section of a paper machine. A large amount of water is drained from the slurry through the forming fabric, leaving the cellulosic fibrous web on the surface of the forming fabric.

The newly formed cellulosic fibrous web proceeds from the forming section to a press section, which includes a series of press nips. The cellulosic fibrous web passes through the press nips supported by a press fabric, or, as is often the case, between two such press fabrics. In the press nips, the cellulosic fibrous web is subjected to compressive forces which squeeze water therefrom, and which adhere the cellulosic fibers in the web to one another to turn the cellulosic fibrous web into a paper sheet. The water is accepted by the press fabric or fabrics and, ideally, does not return to the paper sheet.

The paper sheet finally proceeds to a dryer section, which includes at least one series of rotatable dryer drums or cylinders, which are internally heated by steam. The newly formed paper sheet is directed in a serpentine path sequentially around each in the series of drums by a dryer fabric, which holds the paper sheet closely against the surfaces of the drums. The heated drums reduce the water content of the paper sheet to a desirable level through evaporation.

It should be appreciated that the forming, press and dryer fabrics all take the form of endless loops on the paper machine and function in the manner of conveyors. It should further be appreciated that paper manufacture is a continuous process which proceeds at considerable speeds. That is to say, the fibrous slurry is continuously deposited onto the forming fabric in the forming section, while a newly manufactured paper sheet is continuously wound onto rolls after it exits from the dryer section.

Texturing belts in the papermaking and nonwovens fields are used to make three-dimensional nonwoven and tissue and towel structures. Typically, these belts are employed in the forming and pressing sections of e.g., the papermaking process where an increase in caliper of the belting can directly impart caliper, bulk, and three-dimensional patterning in the textured products produced, such as rolled goods. For this type of texturing belt, there usually exists a base weave for, e.g., dimensional stability and load-bearing properties. Often, these belts have a second layer top surface added to the base weave specifically to impart caliper, texture, pattern, and bulk. This top surface can be made from a thermoplastic or thermoset material and is either applied directly in a melted or liquid form, or first produced as a sheet and then subsequently bonded to the surface of the base fabric of the belt. Bonding can either be chemical or thermal, or a combination thereof.

### SUMMARY OF THE DISCLOSURE

The present disclosure concerns an extruded nonwoven industrial fabric with linear components disposed in a machine direction (MD) of the fabric and an extruded polymeric matrix material at least partially encapsulating one or more of the linear components. The present disclosure further provides methods for forming an extruded nonwoven industrial fabric with linear components disposed in a machine direction of the fabric and an extruded polymeric matrix material at least partially encapsulating one or more of the linear components.

In some embodiments, the extruded polymeric matrix material at least partially encapsulating one or more linear components provides sufficient cross-machine direction (CD) reinforcement for the industrial fabric. In other embodiments, all linear components in the industrial fabric are disposed in the MD.

In certain embodiments, the fabric is impermeable. In certain other embodiments, the fabric is permeable.

In certain embodiments, the matrix material fully encapsulates one or more of the linear components. In certain other embodiments, the matrix material fully encapsulates some or all of the linear components.

In certain embodiments, the linear components are yarns. In certain other embodiments, the linear components are multifilaments, monofilaments, cords, spun yarns, or tapes. In yet other embodiments, the linear components are thermoset plastics, thermoplastics, carbon, glass, polyesters, polyolefins, or polyamides. In some embodiments, the fabric comprises at least two different types of linear components. In certain embodiments, the linear components differ in one or more of number, material composition, or size.

In certain embodiments, the linear components are extruded with the polymeric matrix material. In certain embodiments, this may be done by crosshead extrusion and may be done in a spiral configuration.

In certain embodiments, the linear components are parallel to each other.

In certain embodiments, the linear components are in a single plane. In certain other embodiments, the linear components are in a plurality of planes.

In certain embodiments, the linear components have a sufficient modulus to be load-bearing.

In certain embodiments, the extruded polymeric matrix material includes nanoparticles, nanomaterials, fiber materials, glass, carbon, inorganic fillers, and/or polymeric material. In some embodiments, the nanoparticles, nanomaterials, fiber materials, glass, carbon, inorganic fillers, and/or polymeric material are incorporated throughout the extruded polymeric matrix material or a portion thereof. In yet other embodiments, the extruded polymeric matrix material may include thermoplastics, polyurethane, polyesters, polyamides, co-polyesters, co-polyamides, hot melt glues, a co-polymer of thermoplastic polyurethane (TPU) with acrylic, a co-polymer of TPU with a polyester elastomer, or a co-polymer of TPU with a polyamide elastomer.

In certain embodiments, the extruded polymeric matrix material comprises a first side and a second side and wherein the first side and the second side are planar and the linear components do not extend through the first side or the second side. In certain other embodiments, at least a portion of the linear components at least partially extend through the first side and/or the second side.

In certain embodiments, a pattern is formed on a face of the fabric by laser etching, mechanical etching, embossing, or resin deposition.

In certain embodiments, a pattern is formed on a face of the fabric by an additive process, such as resin deposition such as a three-dimensional printing technique or an ink-jet printer technique. In yet other embodiments, a pattern is formed on a face of the fabric by a subtractive process.

In certain embodiments, the nonwoven industrial fabric is selected from the group consisting of: a conveyor belt; a papermachine clothing (“PMC”), wherein the PMC is a forming fabric, a press fabric, a dryer fabric, a shoe press belt, a transfer belt, a reel belt, a Through Air Drying (“TAD”) fabric, an impression fabric, an Energy Efficient Technologically Advanced Drying (“eTAD”) fabric, an Advanced Tissue Molding Systems (“ATMOS”) fabric or belt, a New Tissue Technology (“NTT”) fabric or belt, or a structured fabric; a double nip thickener (“DNT”) fabric; a belt filter; a pulp washer; a belt, a fabric, or a sleeve for the production of airlaid, spunbond, melt spun, or hydroentangled nonwoven material; a belt to produce a building product; a belt to produce oriented strand board (“OSB”); a corrugator belt; a textile finishing belt; a sanforizing belt; a tannery belt; and a tannery sleeve.

### BRIEF DESCRIPTION OF THE DRAWINGS

FIG. 1 is a perspective, partially cut-away view of an embodiment of a fabric of the present disclosure, including a textured faceside.

FIG. 2 is a perspective, partially cut-away view of an embodiment of a fabric of the present disclosure, including a smooth faceside.

FIG. 3 is a cross-sectional view along a transverse (cross-machine (CD)) direction of an embodiment of the fabric of the present disclosure.

FIG. 4 is a cross-sectional view along a transverse (CD) direction of another embodiment of the present disclosure with partially exposed linear components.

FIG. 5 is a cross-sectional view along a transverse (CD) direction of an embodiment of the fabric of the present disclosure, with apertures passing through the fabric, resulting in a permeable configuration.

FIG. 6 is a cross-sectional view along a transverse (CD) direction of an embodiment of the fabric of the present disclosure, with first and second types of linear components.

FIG. 7 is a cross-sectional view along a transverse (CD) direction of an embodiment of the fabric of the present disclosure, with linear components being configured and arranged in first and second parallel planes.

FIG. 8 is a cross-sectional view along a transverse (CD) direction of an embodiment of the fabric of the present disclosure, including an upper coating layer or film.

FIG. 9 is a cross-sectional view along a transverse (CD) direction of an embodiment of the fabric of the present disclosure, illustrating additive patterning as may be achieved by resin deposition on a faceside of a fabric of the present disclosure.

FIG. 10 illustrates a continuous additive pattern (dark areas are additive) as may be achieved by resin deposition on a faceside of a fabric of the present disclosure with respect to FIG. 9. FIG. 10 equally illustrates a continuous subtractive pattern (white areas are removal) with respect to FIG. 12.

FIG. 11 illustrates a discrete additive pattern (dark areas are additive) as may be achieved by resin deposition on a faceside of a fabric of the present disclosure with respect to FIG. 9. FIG. 11 equally illustrates a discrete subtractive pattern (white areas are removal) with respect to FIG. 12.

FIG. 12 is a cross-sectional view along a transverse (CD) direction of an embodiment of the fabric of the present disclosure, illustrating subtractive or removal patterning as may be achieved on a faceside of a fabric of the present disclosure.

FIG. 13 illustrates an apparatus for producing a spiral configuration of one of the embodiments of a fabric of the present disclosure.

FIG. 14 is a cross-sectional view along a machine direction of an embodiment of the fabric of the present disclosure.

FIG. 15 is a plan view of a subtractive surface formed on a faceside of an embodiment of the fabric of the present disclosure.

FIG. 16 is a plan view of an additive surface, including perforations within the additive material, formed on the faceside of an embodiment of the fabric of the present disclosure.

FIG. 17 is a plan view of the backside of the embodiment of the fabric illustrated in FIG. 16, further illustrating the perforations passing through the fabric.

FIG. 18 is a transverse (CD) cross-sectional view of the perforations of the embodiment of the fabric illustrated in FIGS. 16 and 17.

FIG. 19 is a plan view of an additive surface, with additive material forming elements resembling a bicycle chain link, and with no through holes, formed on the faceside of an embodiment of the fabric of the present disclosure.

FIG. 20 is a plan view of an additive surface, with additive material forming dumbbell type shapes, and with no through holes, formed on the faceside of an embodiment of the fabric of the present disclosure.

FIG. 21 is a further plan view of an additive surface, with additive material forming dumbbell type shapes, and with no through holes, formed on the faceside of an embodiment of the fabric of the present disclosure.

FIG. 22 is a cross-sectional view of an embodiment of the fabric of the present disclosure, showing filler particles within the resin matrix.

### DETAILED DESCRIPTION

The terms “comprising” and “comprises” in this disclosure can mean “including” and “includes” or can have the meaning commonly given to the term “comprising or comprises” in U.S. Patent Law. Terms “consisting essentially of” or “consists essentially of” if used in the claims have the meaning ascribed to them in U.S. Patent Law. Other aspects of the disclosure are described in the disclosure or are known to those of ordinary skill in the art, after review of the disclosure.

The terms “yarns” and “fibers” are used interchangeably in the following disclosure and can refer to monofilaments, multifilament yarns, twisted yarns, textured yarns, coated yarns, otherwise spoolable material, as well as yarns made from stretch broken fiber known to those ordinarily skilled in the art. Yarns can be made of carbon, rayon, fiberglass, cotton, ceramic, aramid, polyester, polyolefins, metal, polyethylene, glass, polyamide, polyphenylene sulphide (PPS), and/or polyether ether ketone (PEEK) materials in the form of multifilaments, monofilaments, cords, spun yarns, tapes, twisted tow yarns, untwisted tow yarns, and/or other materials and forms that exhibit desired physical, thermal, chemical, or other properties. Yarns can further be thermoplastics, thermoset elastics (elastomers), high modulus elastics (e.g., sufficient to be load-bearing) and/or non-elastics and can still further be fusible sheath/core yarns with a higher melting point core than the surrounding sheath.

The terms “machine direction” (MD) and “cross-machine direction” (CD) as used in the following disclosure are used in accordance with their well-understood meaning in the art. That is, the MD of an industrial fabric, such as a belt, refers to the direction that the industrial fabric moves in a manufacturing process, such as a tissue/towel or nonwovens making process, while CD refers to a direction perpendicular to the MD of the industrial fabric.

The present disclosure concerns a nonwoven industrial fabric, such as a belt, that may be used in any number of industrial processes, including papermaking processes. The fabric or belt comprises linear components disposed in the MD and a matrix material at least partially encapsulating one or more of the linear components. The fabric or belt may be produced by various methods rendering its production comparatively simple, such as, for example, a spiraling technique with co-extruded polymers that form a matrix thereby encapsulating linear components and forming first and second sides of the fabric or belt.

The linear components can be continuous systems, such as yarns, cords, tapes, or similar spoolable material. The linear components may be tension bearing and/or flexible. In certain embodiments, the linear components have a sufficiently high modulus to be load-bearing. A linear component of the invention may comprise any suitable material, such as an elastic or non-elastic thermoset plastic, thermoplastic, carbon, rayon, fiberglass, cotton, ceramic, aramid, polyester, metal, polyethylene, glass, polyamide, polyphenylene sulphide (PPS), and/or polyether ether ketone (PEEK) materials in the form of multifilaments, monofilaments, cords, spun yarns, tapes, twisted tow yarns, untwisted tow yarns, and/or other materials and forms that exhibit desired physical, thermal, chemical, or other properties. Further embodiments of a linear component include a linear component comprising a coating and embodiments where the linear component comprises a core and a fusible sheath, e.g., where the melting point of the core material is higher than that of the fusible sheath material.

The linear components, such as yarns, are arranged in the MD of an industrial fabric of the invention. The linear components may be arranged adjacent to one another in the MD and spaced a certain distance apart from one another. In some embodiments, the linear components are arranged in the MD in a substantially parallel array. In further embodiments, the linear components are in substantially the same plane. In other embodiments, the linear components are in different planes. In a further embodiment, the industrial fabric includes a plurality of planes of linear components wherein the planes are not parallel to each other, in whole or in part. In yet other embodiments, at least two linear components are in parallel planes to one another while other linear components in the industrial fabric are in planes not parallel to the planes of the at least two linear components.

An industrial fabric of the invention may comprise one or more layers of linear components running in the MD that are at least partially encapsulated by a polymeric matrix material. In certain embodiments, the linear components are fully encapsulated by the polymeric matrix material.

The linear components may vary in number, material composition, and/or size (e.g., yarn diameter) within an industrial fabric of the invention. In certain embodiments, the linear components each comprise the same material and are the same size (e.g., diameter).

In making an industrial fabric of the invention, a strip of polymeric matrix material (e.g., a resin) is typically extruded with the linear components in the machine direction of the fabric or belt. This extrusion of the polymeric matrix material and of the linear components may be characterized as co-extrusion, namely, simultaneous extrusion or extrusion at the same time. Crosshead extrusion may be utilized for this operation wherein the polymeric matrix material is melted and extruded together with previously manufactured linear components. Some embodiments may use an extrusion that is only a few inches wide.

An industrial fabric of the invention is envisioned to be produced in endless belt form, but some embodiments may be produced in flat form.

The polymeric matrix material, such as a resin, encapsulates one or more of the linear components. Encapsulation of the one or more linear components in the polymeric matrix material joins the linear components to make a nonwoven industrial fabric of the invention. In some embodiments, one or more linear components is partially encapsulated in the matrix material. In other embodiments, one or more linear components is wholly encapsulated in the matrix material. In certain embodiments, all linear components in an industrial fabric of the invention are wholly encapsulated by the polymeric matrix material.

The polymeric matrix material (e.g., resin) can be made of any suitable polymeric material for encapsulating one or more linear components. It is envisioned that many different extrudable polymer systems can be utilized, including, but without limitation, thermoplastics, polyurethanes, polyesters, polyamides, co-polyesters, co-polyamides, hot melt glues, co-polymers of thermoplastic polyurethane with acrylics, polyester elastomers, polyamide elastomers, and similar polymer systems. Typically, the polymeric matrix material will have a melting temperature lower than that of the linear components.

The polymeric matrix material can likewise be further reinforced by inclusion of fibers, which may be chopped, such as carbon, glass, spunbond polyethylene, polyamides, polyesters, or similar materials such as polymeric fibers, airlaid, fine woven fabrics, etc. The polymeric matrix material may further include spunbonded, spunlaced, meltblown, or needled fiber structures or fabrics, in order to increase the integrity and overall strength of the fabric. Similarly, the polymeric matrix material can be further reinforced by the inclusion of nanoparticles, nanomaterials, inorganic filler particles (e.g., clays, SiO₂), and/or fiber materials, such as, without limitation, glass, carbon, inorganic fillers, or polymeric material to increase the physical properties of the resulting matrix. The reinforcing material, such as nanoparticles or nanomaterials, may be incorporated throughout the polymeric matrix material or incorporated in one or more portions of the polymeric matrix material. In certain embodiments, the reinforcing material, such as nanoparticles or nanomaterials, is incorporated evenly throughout the polymeric matrix material.

The polymeric matrix material in which the MD linear components are at least partially encapsulated provides sufficient reinforcement in the cross-machine direction (CD) of an extruded industrial fabric of the invention such that linear components running in the CD are not required. Accordingly, in various embodiments of the instant invention, all linear components are arranged in the MD of the extruded industrial fabric. In these embodiments, there are no linear components arranged in the CD of the extruded industrial fabric. Likewise, in additional embodiments, the polymeric matrix material of an industrial fabric of the instant invention provides sufficient CD reinforcement such that a woven fabric layer having interwoven weft (CD) yarns, such as a woven base fabric having interwoven warp and weft yarns, is not required. Thus, in various embodiments, an industrial fabric of the invention comprises only an extruded polymeric matrix material with MD linear components at least partially encapsulated therein, where the fabric optionally comprises on its faceside or machine side surface an applied coating or film and/or is patterned on its faceside or machine side surface. In certain of these embodiments, the extruded polymeric matrix comprises further reinforcement as described above, e.g., chopped fibers, nanoparticles, nanomaterials, organic fillers, etc. that are incorporated in whole or in part throughout the polymeric matrix material in a random fashion, e.g., not ordered in the CD of the fabric.

An industrial fabric of the invention, such as a belt, may be used in any number of industrial processes, including papermaking processes. In some embodiments, an industrial fabric of the invention is suitable for use as a papermachine clothing (“PMC”), such as forming fabrics, press fabrics, dryer fabrics, shoe press belts, transfer belts, reel belts, Through Air Drying (“TAD”) fabrics, impression fabrics, Energy Efficient Technologically Advanced Drying (“eTAD”) fabrics, Advanced Tissue Molding Systems (“ATMOS”) fabrics or belts, New Tissue Technology (“NTT”) fabrics or belts, structured fabrics, as well as double nip thickener (“DNT”) fabrics, belt filters, pulp washer fabrics, belts/fabrics/sleeves for the production of nonwovens (for example, airlaid, spunbond, melt spun, hydroentangled), belts to produce building products (for example, oriented strand board (“OSB”)), corrugator belts, textile finishing belts (for example, sanforizing belts), or tannery belts or sleeves.

Various embodiments of the instant invention include fabrics with a faceside (or paperside) surface that is plain, patterned (impermeable), drilled patterned (permeable), or both patterned and drilled patterned, additive or removal patterned. These embodiments may be used for, e.g., transfer belt, NTT belt, PMC, or conveyor belt applications. In order to optimize the fabric (e.g., a belt) for use in a dewatering process, such as a forming section, press section, or dryer section, as well as use as a transfer belt or conveyor belt in a paper machine or a tissue production machine, the surface should allow a uniform pressure distribution and/or include a pattern on the faceside to be imprinted on the paper, board, tissue, or other material produced thereon. In certain embodiments, a fabric or belt of the invention including a patterned or unpatterned faceside may be used in such industrial applications as production of nonwovens, spunlace, building products, tissue, towel, board, shingles, medium-density fiberboard (MDF), and similar products. The fabric or belt can be configured to include a faceside and a backside formed from the polymer matrix so as to be impermeable to gas and/or liquid, such as water. However, in certain other embodiments, the fabric or belt may include perforations formed therethrough by mechanical, laser, or similar methods to provide for gas and/or liquid permeability. Other embodiments of the industrial fabric may include both permeable and impermeable sections or portions.

In certain embodiments, the patterning of the faceside (or “paperside”) may vary in depth up to the maximum caliper of the final product (e.g., tissue or towel) produced thereon when patterned, without limitation, by such methods as laser, etching, or other type of surface removal techniques (similar to gravure printing or negative relief). The patterning may be prepared by such techniques, without limitation, as embossing techniques (e.g., from a patterned roll, belt, or other patterned media) or patterned by resin deposition onto the surface (e.g., similar to letterpress printing or positive relief). The resin deposition may be applied by three-dimensional printing techniques, such as ink-jet printing techniques or other resin injection techniques. A wide variety of patterns can be produced, such as, but not limited to, continuous or discontinuous lines, dots, logos, pictures, images, script, and text. Further possibilities for pattern elements include shapes such as, but not limited to, round shapes, polygonal shapes, curves, letters, numbers, words, waves, slits, drawings, trademarks, or any desired shape or combination of shapes to create any random or ordered pattern desired. In certain embodiments, a round shape is a circle or oval. These patterns would typically be implemented on the faceside of a fabric of the invention in, e.g., inverted, reversed, or negative relief configuration, thereby causing a corresponding desired image to be imprinted on the paper, board, tissue, or other product material produced on the industrial fabric, such as a belt, of the instant invention.

In certain embodiments, a spiraling technique may provide channels on a vented backside of the industrial fabric (e.g., a belt) to aid in guiding and stability. In particular embodiments, channels on a vented backside will prevent hydroplaning on a turning roll that is wet. In still further embodiments, the industrial fabric may be vented, and thereby made permeable, by drilled apertures passing fully through the fabric. In other embodiments, the backside may be smooth (planar) or have a variable roughness (including, but not limited to ground, added fibers, or patterned) depending upon application needs, or include batt fibers that are incorporated into the structure of the fabric (e.g., belt). Certain other embodiments may include drilled apertures or vents through the industrial fabric or belt.

Further embodiments include a faceside with a coating or film, e.g., to increase sheet adhesion. For example, in some embodiments, a thin coating, such as a water-based urethane top coat, may be applied to the faceside of a fabric of the invention to increase surface energy for improved sheet adhesion. A coating may be sprayed, coated, or extruded. Other coatings, or in some embodiments, films, may be considered for hydrophobicity or other specific properties and applied to an industrial fabric of the invention. In certain embodiments, a material is applied to the faceside surface of a fabric of the invention as a coating that improves sheet adhesion. In other embodiments, the material may be applied as a laminated film. A coating or film may be applied to a fabric of the invention that is impermeable, permeable, or is a fabric that has both impermeable and permeable portions.

Further, certain embodiments may involve the production of an endless belt via lamination of an impermeable or permeable polymer film on the faceside surface. In certain embodiments, the film is patterned by the methods described for other embodiments.

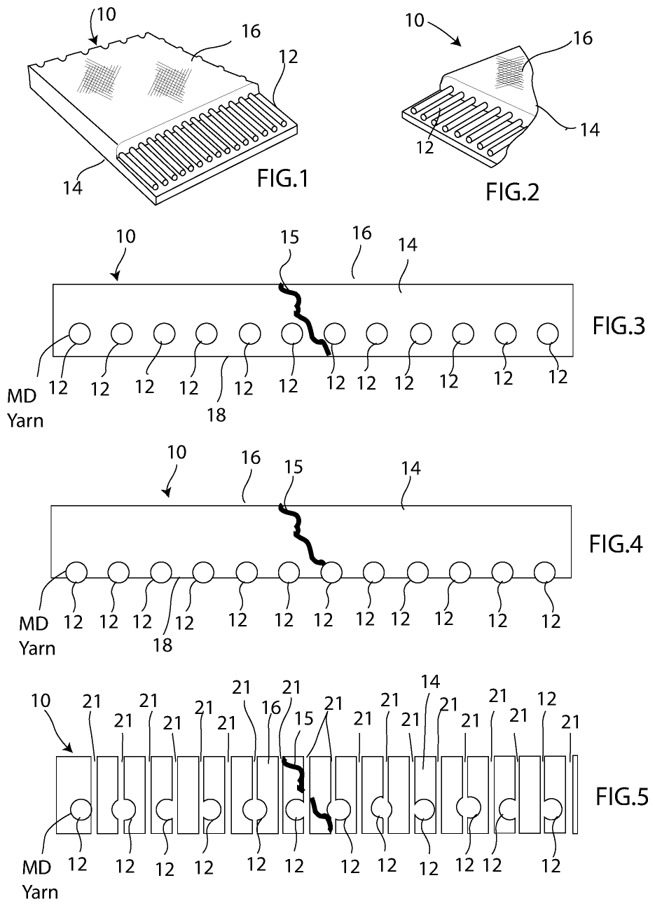

Referring now to the drawings in detail, one sees that FIGS. 1 and 2 illustrate, in cut-away, embodiments of an industrial fabric 10, such as a belt, of the present disclosure. Linear components 12 are oriented in the machine direction and typically have a high modulus of elasticity thereby providing reinforcement and load-bearing capability to the fabric or belt 10, particularly under a machine-direction tensile load. Linear components 12 may be substantially parallel to each other and in substantially one or more planes (see FIG. 7). The linear components 12 can be continuous systems, such as, without limitation yarns, cords, tapes, or similar spoolable material. Linear components 12 can also be configured as multifilaments, monofilament yarns, cords, spun yarns, or tapes.

The linear components 12 are typically co-extruded, e.g., via crosshead extrusion, with a polymeric matrix material, e.g., a resin, thereby forming a resin matrix 14 with the linear components 12 encompassed within resin matrix 14. Many different extrudable polymer resin systems can be utilized, including, but without limitation, thermoplastics, polyurethanes, polyesters, polyamides, co-polyesters, co-polyamides, hot melt glues, co-polymers of thermoplastic polyurethane (TPU) with acrylics, polyester elastomers, polyamide elastomers, and similar polymer systems. While FIGS. 1 and 2 are illustrated in cut-away so as to expose the linear components 12, the linear components 12 of the finished fabric or belt 10 may be completely encompassed by the resin matrix 14 as shown in FIG. 3 or partially exposed as shown in FIG. 4 or some combination of both.

The resin matrix 14 can likewise be further reinforced by inclusion of fibers, which may be chopped, such as carbon, glass, spunbond polyethylene, polyamides, polyesters, or similar materials such as polymeric fibers, airlaid, fine woven fabrics, etc. The resin matrix 14 may further include spunbonded, spunlaced, meltblown, or needled fiber structures or fabrics, in order to increase the integrity and overall strength of a fabric of the invention. Similarly, the resin matrix 14 can be further reinforced by the inclusion of nanoparticles, nanomaterials, inorganic filler particles (e.g., clays, SiO₂), and/or fiber materials such as, without limitation, glass, carbon, inorganic material, or polymeric material to increase the physical properties of the resulting matrix. FIG. 22 illustrates, for example, the use of filler particles 30, which are typically inorganic, in a fabric of the invention.

In certain embodiments, the resin matrix 14 totally encompasses the linear components 12 thereby forming an impermeable faceside (or paperside) 16 and impermeable backside (or machine side) 18, as shown in FIG. 3. In this and similar embodiments, the linear components 12 may be extruded simultaneously with the resin matrix 14 onto a two-roll system in a helically wound manner and produce an endless belt (see the apparatus 100 of FIG. 13) from a creel 104. The extrusion may be only a few inches wide with linear components 12 passing through the extruder (see FIG. 13, extruder 102). Embodiments include fabrics with a faceside (or paperside) surface that is plain, patterned (impermeable), drilled patterned (permeable), or both patterned and drilled patterned, additive or removal patterned. These embodiments may be used for, e.g., transfer belt, NTT belt, PMC, or conveyor belt applications. In some embodiments, as shown in FIG. 3, the linear components 12 are not exposed and do not pass or extend through the impermeable faceside 16 or impermeable backside 18 of the finished fabric or belt 10. In other embodiments, as shown in FIG. 4, the linear components 12 extend partially through the backside 18 of resin matrix 14 so as to be partially exposed. Further, as shown in FIGS. 5, 9, and 12, the industrial fabric or belt 10 may include apertures or vents 21 drilled or otherwise formed through the resin matrix 14, thereby resulting in a permeable configuration. Further, as shown in FIG. 8, the impermeable faceside 16 may include a thin “film” 20, such as a water-based urethane top coat, to increase surface energy for improved sheet adhesion. This thin film 20 may be sprayed, coated, or extruded. Other coatings, or in some embodiments, films, may be considered for hydrophobicity or other specific properties and applied to an industrial fabric of the invention. In certain embodiments, a material is applied to the faceside surface of a fabric of the invention as a coating that improves sheet adhesion. In other embodiments, the material may be applied as a laminated film.

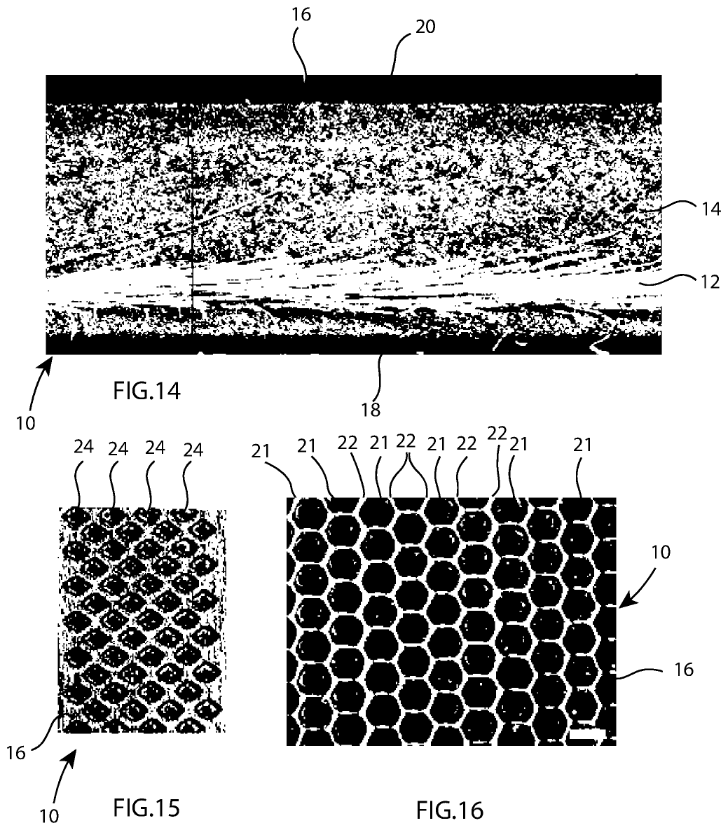

A cross-sectional view along the machine direction of a fabric of the invention is illustrated in FIG. 14, illustrating a linear component 12 (polyethylene terephthalate (PET) yarn fibers) encompassed within a resin matrix 14 (TPU extrudate above and below linear component 12), with a resin coating 20 on the faceside 16 to improve release of a sheet of paper.

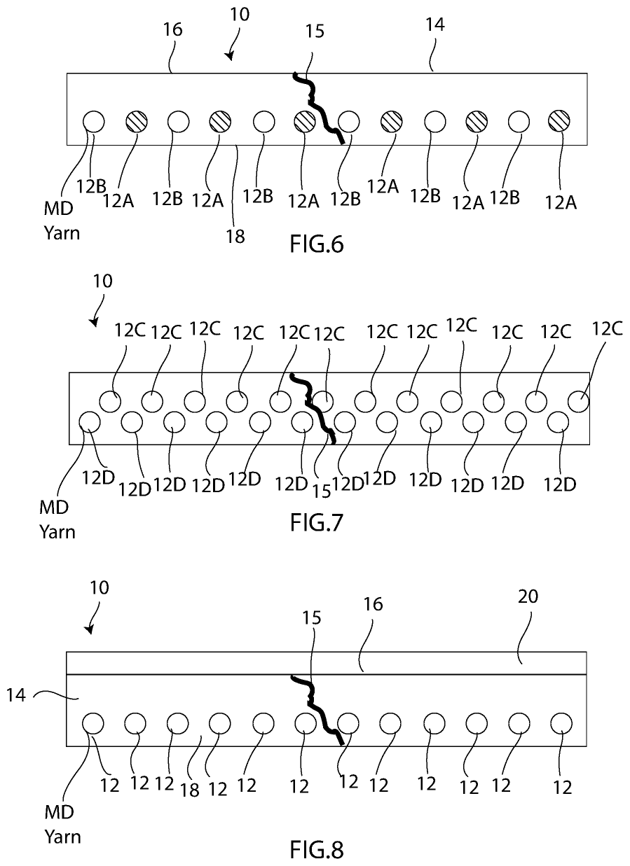

As shown in FIG. 6, the linear components, illustrated as two different types of linear components, 12A and 12B, may be a plurality of types of linear components, such as, but not limited to, different multifilaments, monofilament yarns, cords, spun yarns, or tapes arranged in parallel configuration. Furthermore, as shown in FIG. 7, the linear components 12C, 12D may be configured in a plurality of planes. The linear components 12C of FIG. 7 are illustrated in a first plane and linear components 12D of FIG. 7 are illustrated in a second plane, parallel to the first plane. A further plurality of similar parallel planes, including linear components, may be implemented. A still further embodiment could include a plurality of planes of linear components wherein the planes are not parallel to each other, in whole or in part.

When industrial fabric or belt 10 is produced by methods similar to that illustrated in FIG. 13, sequential extrusion passes, e.g., by means of crosshead extrusion, of linear components 12 and resin matrix 14 may be joined by weld line 15 as illustrated in FIGS. 3-9 and 12. This weld line 15 may be the result of self-joining of the resin as it is placed next to the previous pass of resin. Certain embodiments use materials with sufficient green bonding to survive consolidation to turn the many strips into one band. Other options to form the bonding between strips are hot gas, infra-red, and laser bonding.

In order to optimize the fabric (e.g., belt) for use in a dewatering process, such as a forming section, press section, or dryer section, as well as use as a transfer belt or conveyor belt in a paper machine or a tissue production machine (such as Valmet's Advantage™ NTT® or other textured tissue producing paper machines), the surface of faceside 16 should be prepared to allow a uniform pressure distribution and/or a pattern to be imprinted in the produced paper, board, or tissue. This patterned belt may also be used in other industrial applications, such as building products, etc. In certain embodiments, an industrial fabric, such as a belt, of the instant invention is completely impermeable to air and/or water. Other embodiments of the industrial fabric may include both permeable and impermeable sections or portions. In other embodiments, fabric or belt 10 may be perforated via a variety of means (e.g., laser or mechanical) to provide permeability to gases and/or liquids.

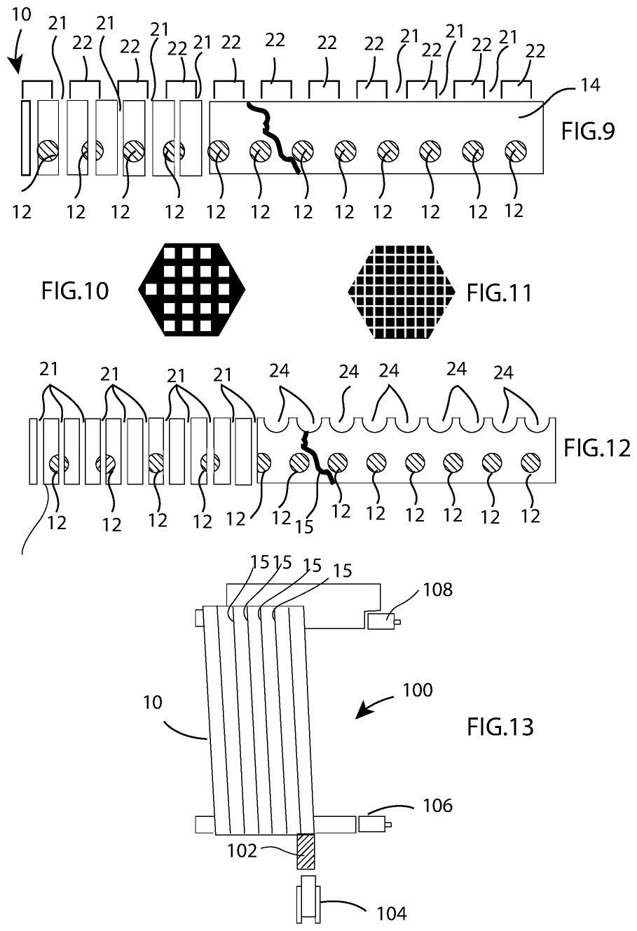

In certain embodiments, the patterning of the faceside 16 may vary in depth when patterned by additive processes, e.g., up to a maximum caliper of the finished product produced on the fabric. As can be seen in FIG. 9, faceside 16 may include additive pattern elements 22, which may be formed by such processes as resin deposition on the resin matrix 14 while maintaining impermeability of faceside 16 in embodiments without apertures or vents 21. These additive pattern elements 22 may form continuous additive patterns 22 as shown in FIG. 10 (dark areas are additive) or may form discretized additive patterns as shown in FIG. 11 (dark areas are additive). A wide variety of patterns can be produced, such as, but not limited to, continuous or discontinuous lines, dots, logos, pictures, images, script, and text. Further possibilities for pattern elements include shapes such as, but not limited to, circles, polygons, waves, slits, drawings, trademarks, or any desired shape or combination of shapes to create any random or ordered pattern desired.

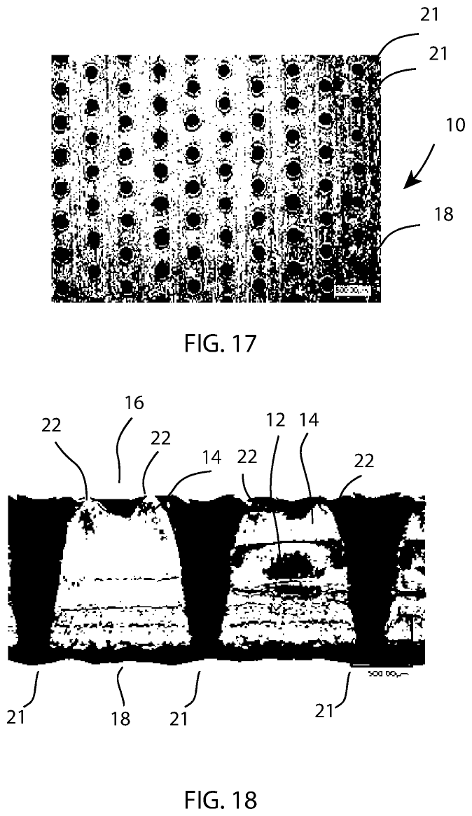

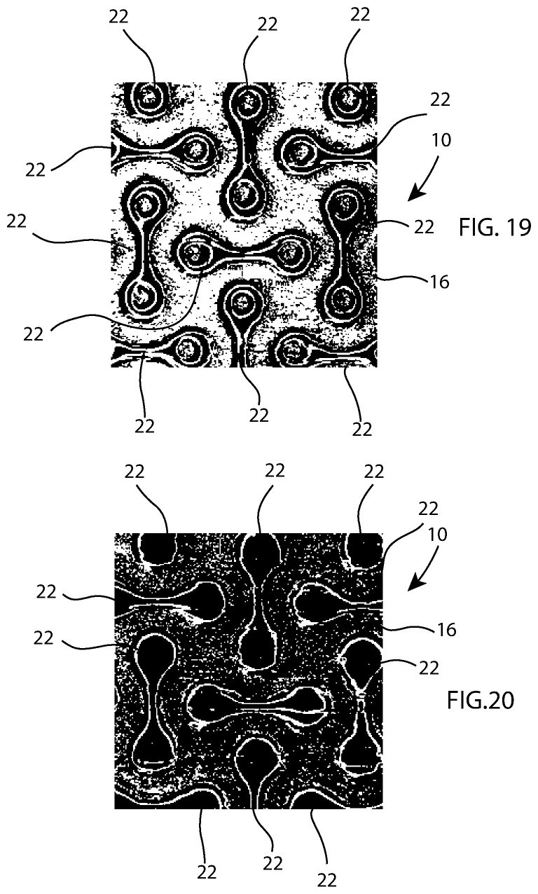

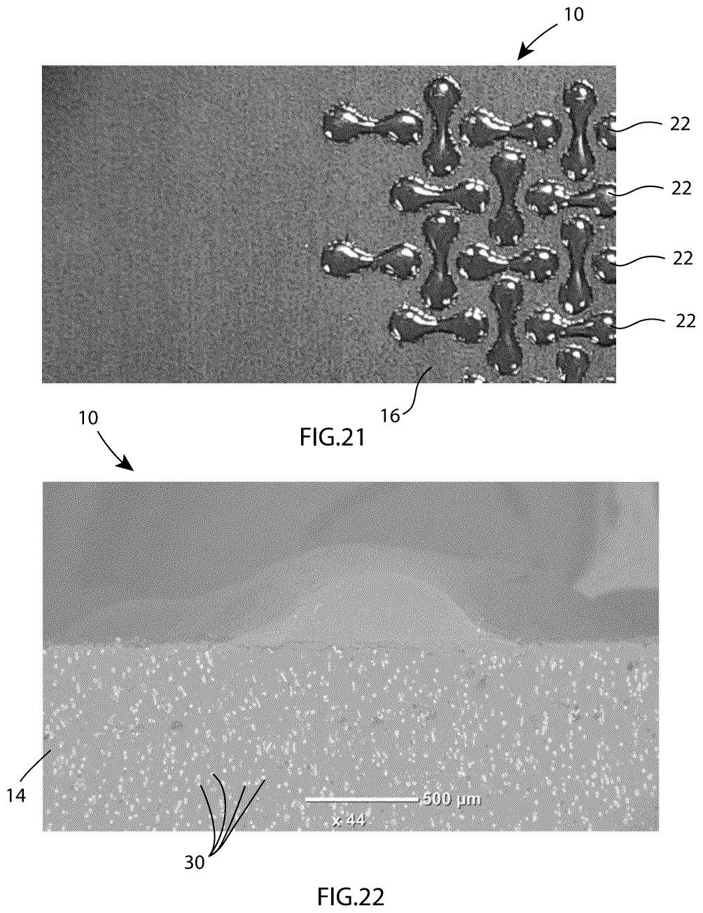

Examples of additive pattern elements on a faceside 16 of a fabric 10 are illustrated in FIGS. 16, 19, 20, and 21. FIG. 16 illustrates resin deposited on the faceside 16 of an extruded fabric 10 thereby forming additive elements 22, with perforations 21 between the additive elements 22. FIG. 17 illustrates the backside 18 of the fabric 10, corresponding to FIG. 16, further illustrating the perforations 21. FIG. 18 illustrates a transverse (CD) cross-sectional view of the fabric 10 of FIG. 16, proximate to the perforations 21. Drilled perforations 21 are shown with additive elements 22 surrounding the periphery of the drilled perforations 21 and may further be formed by the protrusions caused by the drilled or formation of drilled perforations. A circular end view of a linear component 12 is further shown in this figure in the extruded polymeric matrix 14. FIG. 19 illustrates additive elements 22 in a shape resembling a bicycle chain link. Similarly, FIGS. 20 and 21 include additive elements 22 on the faceside 16 that resemble dumbbells. The illustrated embodiments of FIGS. 19-21 do not include any perforations, drilled apertures, or vents 21. However, it is envisioned that there are embodiments of the present disclosure that encompass FIGS. 19-21, but including perforations, vents, or drilled apertures 21. It should be noted that the white lines on additive elements 22 in FIGS. 19 and 20 are due to light reflection in the photographic process.

Similarly, as shown in FIG. 12, faceside 16 may include subtractive pattern elements 24, such as voids and patterns in the resin matrix 14, which are formed by material removal, such as, but not limited to, laser, etching, or other type of surface removal techniques (similar to gravure printing or negative relief), while maintaining impermeability of faceside 16 in embodiments without apertures or vents 21. These subtractive pattern elements 24 may form continuous subtractive patterns as shown in FIG. 10 (white areas are removal) or may form discretized subtractive patterns 24 as shown in FIG. 11 (white areas are removal). A wide variety of subtractive patterns may be produced, such as, but not limited to, continuous or discontinuous lines, dots, logos, pictures, images, script, and text. Further possibilities for pattern elements include shapes such as, but not limited to, circles, polygons, waves, slits, drawings, trademarks, or any desired shape or combination of shapes to create any random or ordered pattern. FIG. 15 illustrates an embodiment of the present disclosure wherein the faceside 16 includes subtractive elements 24.

In summary, the patterning may be prepared by such techniques, without limitation, as laser techniques or embossing techniques (e.g., from a patterned roll, belt, or other patterned media) or patterned by resin deposition onto the surface (similar to letterpress printing or positive relief). The resin deposition may be applied by three-dimensional printing techniques, such as ink-jet printing techniques or other resin injection techniques. A wide variety of patterns can be produced, such as, but not limited to, continuous or discontinuous lines, dots, logos, pictures, images, script and text. Further possibilities for pattern elements include shapes such as, but not limited to, circles, polygons, waves, slits, drawings, trademarks, or any desired shape or combination of shapes to create any random or ordered pattern desired.

These patterns would typically be implemented on the faceside of a fabric of the invention in inverted, reversed, or negative relief configuration, thereby causing a corresponding desired image to be imprinted on the paper, board, tissue, or other product material produced on the industrial fabric, such as a belt, of the instant invention.

FIG. 13 is illustrative of an apparatus 100 of one method of forming the industrial fabric or industrial belt 10. A resin extruder 102 is provided to crosshead extrude the resin material (of resin matrix 14) and the material of linear components 12 as received from spool 104. Strips of resin material encompassing the linear components are spiral wound around two parallel support “head and tail” rolls 106, 108 (the distance between rolls 106, 108 defining the length of the resulting industrial belt 10) with adjacent passes of the extruded material being joined together at weld lines 15 (also see FIGS. 3 and 4).

In certain embodiments, the spiraling technique may provide channels on a vented backside to aid in dewatering, guiding, and stability. In other embodiments, the backside may be smooth or planar, have a variable roughness or include batt fibers that are incorporated into the structure of the fabric (e.g., belt).

Modifications to the above would be obvious to those of ordinary skill in the art, but would not bring the invention so modified beyond the scope of the present invention. The claims to follow should be construed to cover such situations.

What is claimed is:

1. A nonwoven industrial fabric for texturing a product comprising:
linear components disposed in a machine direction (MD) of the fabric; and
an extruded polymeric matrix material at least partially encapsulating one or more of the linear components,
wherein a first side of the nonwoven industrial fabric comprises a pattern formed by additive and/or subtractive elements for imparting a desired texture on a product.

2. The nonwoven industrial fabric of claim 1, wherein the extruded polymeric matrix material fully encapsulates one or more of the linear components.

3. The nonwoven industrial fabric of claim 1, wherein the extruded polymeric matrix material fully encapsulates all of the linear components.

4. The nonwoven industrial fabric of claim 1, wherein the linear components are substantially parallel to one another.

5. The nonwoven industrial fabric of claim 1, wherein the linear components are substantially in the same plane.

6. The nonwoven industrial fabric of claim 1, wherein the linear components are in a plurality of planes.

7. The nonwoven industrial fabric of claim 1, wherein the linear components are crosshead extruded with the polymeric matrix material.

8. The nonwoven industrial fabric of claim 1, wherein the linear components comprise a material selected from the group consisting of: thermoset plastics, thermoplastics, carbon, glass, polyesters, polyolefins, and polyamides.

9. The nonwoven industrial fabric of claim 1, wherein the extruded polymeric matrix material comprises nanoparticles, nanomaterials, fiber materials, glass, carbon, inorganic fillers, and/or polymeric material, optionally incorporated throughout the extruded polymeric matrix material or a portion thereof.

10. The nonwoven industrial fabric of claim 1, wherein the extruded polymeric matrix material is selected from the group consisting of: thermoplastics, polyurethane, polyesters, polyamides, co-polyesters, co-polyamides, hot melt glues, a co-polymer of thermoplastic polyurethane (TPU) with acrylic, a co-polymer of TPU with a polyester elastomer, and a co-polymer of TPU with a polyamide elastomer.

11. The nonwoven industrial fabric of claim 1, wherein the extruded polymeric matrix material comprises a first side and a second side and wherein the first side and the second side are planar and the linear components do not extend through the first side or the second side.

12. The nonwoven industrial fabric of claim 1, wherein the extruded polymeric material comprises a first side and a second side and wherein the first side and/or the second side are planar and one or more linear components at least partially extend through at least one of the first side and the second side.

13. The nonwoven industrial fabric of claim 1, wherein the pattern on the first side is formed by a method selected from the group consisting of: laser etching, mechanical etching, embossing, and resin deposition.

14. The nonwoven industrial fabric of claim 1, wherein the pattern on the first side is formed by a resin deposition technique selected from the group consisting of: a three-dimensional printing technique and an ink-jet printer technique.

15. The nonwoven industrial fabric of claim 1, wherein the nonwoven industrial fabric is selected from the group consisting of: a conveyor belt; a papermachine clothing (“PMC”), wherein the PMC is a forming fabric, a press fabric, a dryer fabric, a shoe press belt, a transfer belt, a reel belt, a Through Air Drying (“TAD”) fabric, an impression fabric, an Energy Efficient Technologically Advanced Drying (“eTAD”) fabric, an Advanced Tissue Molding Systems (“ATMOS”) fabric or belt, a New Tissue Technology (“NTT”) fabric or belt, or a structured fabric; a double nip thickener (“DNT”) fabric; a belt filter; a pulp washer; a belt, a fabric or a sleeve for the production of airlaid, spunbond, melt spun, or hydroentangled nonwoven material; a belt to produce a building product; a belt to produce oriented strand board (“OSB”); a corrugator belt; a textile finishing belt; a sanforizing belt; a tannery belt; and a tannery sleeve.

16. The nonwoven industrial fabric of claim 1, wherein the nonwoven industrial fabric is a papermachine clothing (“PMC”).

17. The nonwoven industrial fabric of claim 1, wherein the fabric comprises at least two different types of linear components.

18. The nonwoven industrial fabric of claim 1, wherein the linear components differ in one or more of number, material composition, or size.

19. The nonwoven industrial fabric of claim 1, wherein the extruded polymeric matrix provides sufficient cross-machine direction (CD) reinforcement for the fabric.

20. The nonwoven industrial fabric of claim 1, wherein all linear components are disposed in the MD.

21. The nonwoven industrial fabric of claim 1, wherein the linear components are yarns.

22. The nonwoven industrial fabric of claim 1, wherein the linear components are selected from the group consisting of: multifilaments, monofilaments, cords, spun yarns, and tapes.

23. The nonwoven industrial fabric of claim 1, wherein the linear components have a sufficient modulus to be load-bearing.

24. A method of forming the nonwoven industrial fabric of claim 1, comprising: providing linear components disposed in a machine direction (MD) of the fabric; and
extruding polymeric matrix material such that the linear components are at least partially encapsulated in the polymeric matrix material.

25. The method of claim 24, wherein the extruding forms a spiral configuration that forms an endless belt.

26. The method of claim 24, comprising crosshead extruding the polymeric matrix material with the linear components.

27. The method of claim 24, wherein a first side of the nonwoven industrial fabric comprises a pattern.

28. The method of claim 27, wherein the pattern on the first side is formed by a method selected from the group consisting of: laser etching, mechanical etching, embossing, and resin deposition.

29. The method of claim 28, wherein the pattern on the first side is formed by a resin deposition technique selected from the group consisting of: a three-dimensional printing technique and an ink-jet printer technique.

30. The method of claim 24, wherein the nonwoven industrial fabric is selected from the group consisting of: a conveyor belt; a papermachine clothing (“PMC”) wherein the PMC is a forming fabric, a press fabric, a dryer fabric, a shoe press belt, a transfer belt, a reel belt, a Through Air Drying (“TAD”) fabric, an impression fabric, an Energy Efficient Technologically Advanced Drying (“eTAD”) fabric, an Advanced Tissue Molding Systems (“ATMOS”) fabric or belt, a New Tissue Technology (“NTT”) fabric or belt, or a structured fabric; a double nip thickener (“DNT”) fabric; a belt filter; a pulp washer; a belt, a fabric or a sleeve for the production of airlaid, spunbond, melt spun or hydroentangled nonwoven material; a belt to produce a building product; a belt to produce oriented strand board (“OSB”); a corrugator belt; a textile finishing belt; a sanforizing belt; a tannery belt; and a tannery sleeve.

31. A nonwoven industrial fabric comprising:
linear components disposed in a machine direction (MD) of the fabric; and
an extruded polymeric matrix material at least partially encapsulating one or more of the linear components,
wherein the nonwoven industrial fabric is impermeable.

32. The nonwoven industrial fabric of claim 31, wherein the extruded polymeric matrix provides sufficient cross-machine direction (CD) reinforcement for the fabric.

33. The nonwoven industrial fabric of claim 31, wherein all linear components are disposed in the MD.

34. The nonwoven industrial fabric of claim 31, wherein the linear components are yams.

35. A nonwoven industrial fabric comprising:
linear components disposed in a machine direction (MD) of the fabric;
an extruded polymeric matrix material at least partially encapsulating one or more of the linear components, and
wherein the extruded polymeric material comprises a first side and a second side and wherein the first side and the second side are planar and one or more of the linear components at least partially extend through at least one of the first side and the second side.

36. A nonwoven industrial fabric comprising:
linear components disposed in a plurality of planes in a machine direction (MD) of the fabric; and
an extruded polymeric matrix material at least partially encapsulating one or more of the linear components disposed in the plurality of planes.
